(19) United States
(12) Patent Application Publication
(10) Pub. No.: US 2009/0112725 A1
(43) Pub. Date: Apr. 30, 2009

(54) ERRATA NOTIFICATION FOR PRINTED MATERIAL

(75) Inventors: Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/928,453

(22) Filed: Oct. 30, 2007

(51) Int. Cl. G06Q 30/00; G06Q 10/00; G06Q 20/00

(52) U.S. Cl. 705/16; 705/1; 705/26

(57) ABSTRACT

Embodiments of the present invention address deficiencies of the art in respect to errata sheet management for published documents and provide a novel and non-obvious method, system and computer program product for errata sheet notification aggregation. In one embodiment of the invention, a method for errata sheet handling in an e-commerce system can be provided. The method can include registering a customer for errata sheet notification for a publication externally to a publisher of the publication and also externally to a publisher of errata sheets for the publication. The method further can include providing a notification to the customer of the publication of the errata sheet in response to determining the publication of an errata sheet for the publication by the publisher of errata sheets for the publication.

### BACKGROUND OF THE INVENTION

1. Field of the Invention

The present invention relates to the field of e-commerce for printed materials and more particularly to errata slip publication for printed materials.

2. Description of the Related Art

The publishing of printed subject matter has always been subject to human error despite best efforts to produce an error free publication. The process of printed materials publishing involves the drafting of printed material followed by the iterative editing of the printed material ultimately resulting in the typesetting and publication of the printed material in hard copy form or soft copy electronic form. Once published, however, the printed material can be subject to revisions of varying scale. The revisions when relatively insignificant can result in a mere update to the printed material, while more significant revisions can require a new edition to the printed material. For typographical and other very minor revisions, however, neither an update nor a new edition is provided. Rather, an errata sheet can be published separately from the publication of the printed material.

An errata sheet is a tabular listing of corrections to an associated publication. Traditionally published for distribution with a work of authorship, errata sheets often include typographical corrections that had been identified subsequent to final editing but prior to final publication and distribution. With the advent of electronic distribution of printed materials, errata sheets often are published and distributed online in electronic format. When an errata sheet is distributed separately from the distribution of a publication, it remains incumbent upon the purchaser of the publication to affirmatively locate and print an errata sheet online. Many consumers, however, are not accustomed to such behavior, and in consequence, remain unaware and without possession of an errata sheet for a purchased work of authorship. This is particularly unfortunate for books of instruction, such as cookbooks, craft pattern books, or history texts.

### BRIEF SUMMARY OF THE INVENTION

Embodiments of the present invention address deficiencies of the art in respect to errata sheet management for published documents and provide a novel and non-obvious method, system and computer program product for errata sheet notification aggregation. In one embodiment of the invention, a method for errata sheet handling in an e-commerce system can be provided. The method can include registering a customer for errata sheet notification for a publication externally to a publisher of the publication. The method further can include providing a notification to the customer of the publication of the errata sheet in response to determining the publication of an errata sheet for the publication by the publisher of errata sheets for the publication.

In another embodiment of the invention, an errata sheet notification data processing system can be provided. The system can include a host server hosting an errata sheet service supporting an errata sheet aggregator. The program code can be enabled to register a customer for errata sheet notification for a publication and to provide a notification to the customer of the publication of an errata sheet for the publication responsive to detecting publication of the errata sheet by an externally disposed errata sheet publisher. Optionally, an aggregation server can be coupled to the host server and configured to process electronic purchases of the publication over a computer communications network. For example, the aggregation server can support a Web based system for an online seller of publications, or a point of sale system for a brick and mortar based retailer of publications, or the aggregation server can support the Web based auction of publications. Yet further, the host server can be the aggregation server.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for errata sheet notification aggregation;

FIG. 2 is a schematic illustration of an e-commerce data processing system configured for errata sheet notification aggregation; and,

FIG. 3 is a flow chart illustrating a process for errata sheet notification aggregation.

### DETAILED DESCRIPTION OF THE INVENTION

Embodiments of the present invention provide a method, system and computer program product for errata sheet notification aggregation. In accordance with an embodiment of the present invention, printed publications can be published by different publishers and distributed to different consumers through an e-commerce aggregator. In the course of distributing the printed publications to the different consumers, electronic messaging addresses for the consumers can be recorded in association with respectively distributed ones of the printed publications. Thereafter, as errata sheets become available for the different printed publications, the different publishers can provide notice to the aggregator which in turn can provide an electronic message to affected ones of the consumers of the availability of an errata sheet. Notably, the management of errata sheet notification be provided by an errata service separate from the aggregator, or as part of the aggregation operations of the aggregator.

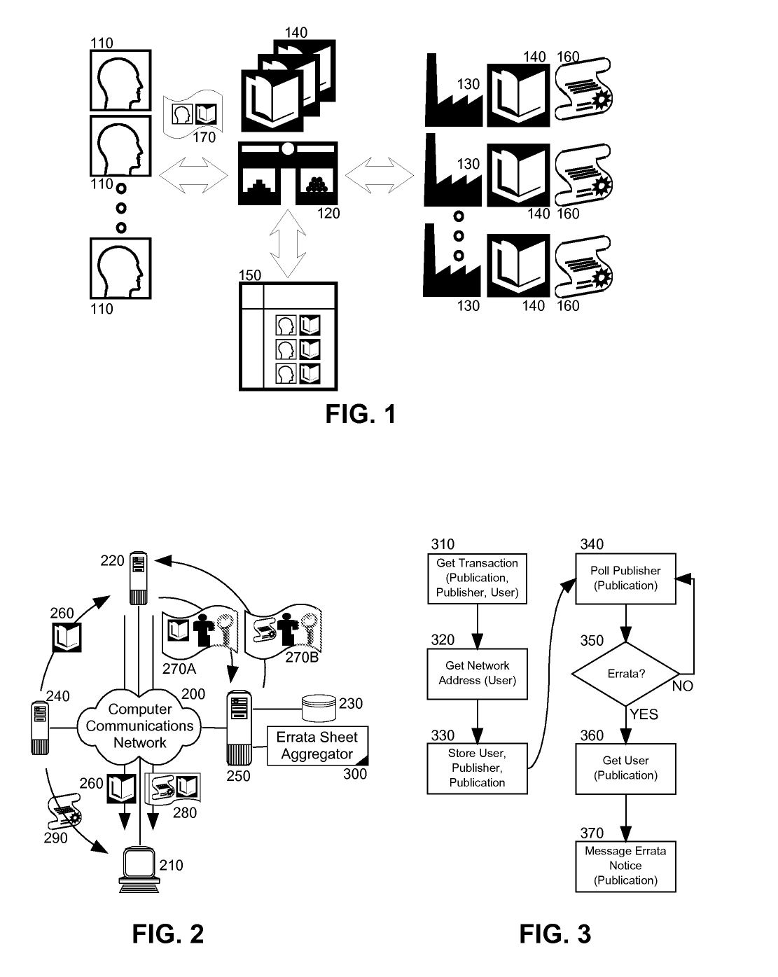

In further illustration, FIG. 1 is a pictorial illustration of a process for errata sheet notification aggregation. As shown in FIG. 1, different publishers 130 can publish different publications 140 for distribution to one or more consumers 110 through aggregator 120. The aggregator 120 can function as an e-commerce distributor of the publications 140 to the different consumers 110. Typical examples of an aggregator 120 can include a Web based e-tailor of publications or a Web based online auction. The aggregator 120 either internally or through a third party errata service can maintain an association 150 of consumers 110 to acquired publications 140. In particular, the association 150 can include a network address for the different consumers 110 to which notifications can be sent. In an alternate embodiment, the customer network address may be kept in a customer or subscriber database.

From time to time, one or more errata sheets 160 can be published by the publishers 130 for respective ones of the publications 140. Either the aggregator 120 or an errata service associated with the aggregator 120 can monitor the publishers 130 for the publication of errata sheets 160. When an errata sheet 160 is published for a particular one of the publications 140, the aggregator 120 can locate corresponding entries in the association 150 and the aggregator 120 can forward a notification 170 to each of the consumers 110 associated with the particular one of the publications 140. In this way, the consumers 110 can maintain an ongoing awareness of the errata sheets 160 without requiring the consumers 110 and the publishers 130 to directly interact with one another. This notification may include the details of the errata sheet.

The process shown in FIG. 1 can be performed in an e-commerce data processing environment. In illustration, FIG. 2 schematically depicts an e-commerce data processing system configured for errata sheet notification aggregation. The system can include a client computing platform 210 coupled to an aggregation server 220 over computer communications network 200. The aggregation server 220 can be configured to provide distribution of publications 260 on behalf of publishers. In this regard, the aggregation server 220 can be communicatively coupled to publisher server 240 so as to exchange communications between aggregation server 220 and publisher server 240. The communications can range from simple notification of the availability of an errata sheet 290 for the publication 260 to business-to-business e-commerce transactions.

Notably, an errata service server 250 acting as a host server supporting an errata sheet service can be coupled to the aggregation server 220 over the computer communications network 200. The errata service server 250 can include a data store 230 configured to store associations between consumers and publications and the errata service server 250 can be configured to support the execution of an errata sheet aggregator 300. The errata sheet aggregator 300 can include program code enabled to process a registration message 270A from aggregation server 220, or from client 210 to store in the data store 230 an association between a customer and a publication. Optionally, in lieu of storing an identity of a customer in association with a publication an encrypted identifier can be provided for the customer so as to preserve the privacy of the customer and to provide the anonymous registration of the customer for errata sheet notification.

The program code of the errata sheet aggregator 300 yet further can be configured to provide an errata sheet notice 270B to the aggregation server 220 responsive to detecting publication of an errata sheet 290 for publication 260. In this regard, the errata sheet aggregator 300 can be configured to monitor the publisher server 240 to detect publication an errata sheet 290 for the publication 260. In response to detecting publication of the errata sheet 290, at least one errata sheet notice 270B can be forwarded to the aggregation server 220 indicating availability of the errata sheet for each associated customer associated with the publication 260. The aggregation server 220 in turn can forward a customer notice 280 to the client computing platform 210 at a network address for an associated customer so that the customer can retrieve the errata sheet 290 from the publisher server 240. Where only an encrypted customer identifier is provided to the errata service server 250, the aggregation server 220 first can correlate the identifier with a network address for an associated customer. In an alternate embodiment, the errata sheet aggregator 300 can forward the errata sheet notification directly to the customer.

In yet further illustration of the operation of the errata sheet aggregator 300, FIG. 3 is a flow chart illustrating a process for errata sheet notification aggregation. The process can begin in block 310 with the receipt of a registration transaction requesting registration of a customer in association with a publication and optionally, a publisher of the publication. In block 320, the network address of the customer can be determined from the transaction and in block 330, the customer identity can be stored in association with the publication and optionally, the publisher. In one aspect of the embodiment, only an alias for the customer identity can be stored in lieu of the customer identity.

In block 340, the publisher can be polled for the publication of an errata sheet for the publication. For example, the publisher can proactively provide notification of the publication of an errata sheet, or the publisher can be monitored for the publication of an errata sheet. In decision block 350, it can be determined if an errata sheet has been published for the publication. If so, in block 360, the customers associated with the publication can be retrieved and in block 370, an errata sheet notification can be provided to the customers in association with the publication. In this way, the customers can remain apprised of the publication of errata sheets without proactively investigating the publication of errata sheets directly with the publisher.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A computer implemented method for errata sheet handling, the method comprising:
registering a recipient of a purchased publication externally to a publisher of the publication; and,
providing a notification to the recipient of the purchased publication of the errata sheet in response to determining a publication of an errata sheet for the purchased publication by the publisher of errata sheets for the publication.

2. The method of claim 1, wherein registering a recipient of a purchased publication externally to a publisher of the publication, comprises registering a recipient of a purchased publication in an aggregator of publications responsive to distributing the publication.

3. The method of claim 1, wherein registering a recipient of a purchased publication externally to a publisher of the publication, comprises registering a recipient of a purchased publication in an errata service coupled to an aggregator of publications responsive to distributing the publication.

4. The method of claim 1, wherein registering a recipient of a purchased publication externally to a publisher of the publication, comprises anonymously registering a recipient of a purchased publication in an aggregator of publications responsive to distributing the publication.

5. The method of claim 1, further comprising polling the publisher of errata sheets to determine the publication of an errata sheet for the publication.

6. The method of claim 1, further comprising receiving notice from the publisher of errata sheets of the publication of an errata sheet to determine the publication of an errata sheet for the publication.

7. An errata sheet notification data processing system comprising:
a host server hosting an errata sheet service providing an errata sheet aggregator comprising program code enabled to register a recipient of a purchased publication, and provide a notification to the recipient of the purchased publication of an errata sheet for the publication responsive to detecting publication of the errata sheet by an externally disposed errata sheet publisher.

8. The system of claim 7, further comprising an aggregation server coupled to the host server and configured to process an electronic purchase of the purchased publication over a computer communications network.

9. The system of claim 8, wherein the aggregation server is a Web based retailer of publications.

10. The system of claim 8, wherein the aggregation server is a point of sale system for a brick and mortar retailer of publications.

11. The system of claim 8, wherein the aggregation server conducts online auctions of publications.

12. The system of claim 8, wherein the host server is the aggregation server.

13. A computer program product comprising a computer usable medium embodying computer usable program code for errata sheet handling, the computer program product comprising:
computer usable program code for registering a recipient of a purchased publication externally to a publisher of the publication; and,
computer usable program code for providing a notification to the recipient of the purchased publication of the errata sheet in response to determining a publication of an errata sheet for the purchased publication by the publisher of errata sheets for the publication.

14. The computer program product of claim 13, wherein the computer usable program code for registering a recipient of a purchased publication externally to a publisher of the publication, comprises computer usable program code for registering a recipient of a purchased publication in an aggregator of publications responsive to distributing the publication.

15. The computer program product of claim 13, wherein the computer usable program code for registering a customer for errata sheet notification for a publication externally to a publisher of the publication, comprises computer usable program code for registering a customer for errata sheet notification for a publication in an errata service coupled to an aggregator of publications responsive to distributing the publication.

16. The computer program product of claim 13, wherein the computer usable program code for registering a recipient of a purchased publication externally to a publisher of the publication, comprises computer usable program code for anonymously registering a recipient of a purchased publication in an aggregator of publications responsive to distributing the publication.

17. The computer program product of claim 13, further comprising computer usable program code for polling the publisher of errata sheets to determine the publication of an errata sheet for the publication.

18. The computer program product of claim 13, further comprising computer usable program code for receiving notice from the publisher of errata sheets of the publication of an errata sheet to determine the publication of an errata sheet for the publication.
